(19) United States
(12) Patent Application Publication
(10) Pub. No.: US 2006/0282298 A1
(43) Pub. Date: Dec. 14, 2006

(54) Diary management method and system

(76) Inventors: Behnam Azvine, Ipswich (GB); Behrad Assadian, Ipswich (GB); Heather R. Maclaren, Vancouver (CA)

Correspondence Address: NIXON & VANDERHYE, PC, 901 NORTH GLEBE ROAD, 11TH FLOOR, ARLINGTON, VA, 22203, US

(21) Appl. No.: 10/568,183

(22) PCT Filed: Sep. 2, 2004
(86) PCT No.: PCT/GB04/03741

§ 371 Date: Feb. 13, 2006

(30) Foreign Application Priority Data
Sep. 10, 2003 (GB) 0321213.1

(51) Int. Cl. G05B 19/418

(52) U.S. Cl. 705/8

(57) ABSTRACT

Methods and systems are provided for deriving a user model from a plurality of event records relating to events, each event record comprising data relating to attributes of an event, the method comprising: identifying a plurality of sequences of event records from said plurality of event records, each sequence containing a plurality of event records; determining a plurality of sequence clusters from said plurality of sequences, each sequence cluster comprising a plurality of related sequences; analysing the sequences in a cluster and deriving one or more rules relating to the sequences of that cluster; and providing a user model based on rules derived in relation to a plurality of clusters. Methods and systems are also provided for using a user model for suggesting possible events, or sequences of events, which may follow or precede known events, and for determining a potential sequential order for a plurality of known events.

### TECHNICAL FIELD

The present invention relates to methods and systems for deriving user models from information such as event records taken from a user's diary, and for assisting in the use of scheduling systems such as electronic diary systems using such user models.

### BACKGROUND TO THE INVENTION AND PRIOR ART

Intelligent agents that manage diaries for users are available (e.g. “IntelliDiary”, discussed in “An Agent Oriented Schedule Management System: IntelliDiary”, Yuji Wada et al, Proceedings of the First International Conference on the Practical Application of Intelligent Agents and Multi-Agent Systems, pages 655-667, London, UK, April 1996, and “Retsina Semantic Web Calendar Agent”, see: http://www.daml.ri.cmu.edu/Cal/). There are a few existing instances of the personalisation of diary/calendar agents by constructing a model of the user based on experience of their actions. These models have been used to predict details when scheduling meetings on the user's behalf.

In the article “A learning Interface Agent for Scheduling Meetings”, by Kozierok and Maes, (Proceedings of the International Workshop on Intelligent User Interfaces, pages 81-88, New York, USA, January 1992), the authors disclose a meeting scheduler which uses case-based reasoning and reinforcement learning to enable it to negotiate meeting times and dates with other users. In “A Personal Learning Apprentice’ by Dent et al, (Proceedings of the Tenth National Conference on Artificial Intelligence, pages 96-103, July 1992), the authors describe the production of an agent to manage a meeting calendar which uses two competing methods, a set of decision trees and a set of neural nets, to fill in the details of any meetings added by the user to their diary.

User models within diary assistants have previously only been used to predict the details or requirements of meetings when scheduling on the user's behalf, with some of the initial details of the task provided each time by the user (or another user's agent). User models have not been used to predict additional tasks that the user may wish to carry out, or to assist in the scheduling of multiple tasks by suggesting the most likely order for the tasks based on previous experience.

Systems that produce user models of sequences containing more than two items (long sequences) are known (see “Inductive Task Modelling for User Interface Customization”, David Maulsby, Intelligent User Interfaces 1997: 233-236; “Extracting Behavioural Patterns form Relational History Data”, Hiroshi Motoda et al, Proc. of the Workshop “Machine Learning for User Modeling” held in conjunction with Sixth International Conference on User Modeling (June 1997), Chia Laguna, Sardinia, Italy; and “Emotionally Expressive Agents”, Magy Seif El-Nasr et al, Proceedings of Computer Animation '99, Switzerland, 1999). All current systems deal with predicting the user's immediate actions following actions recently observed. The duration of each action is not taken into account when making predictions as the sorts of actions predicted are much smaller and happen over a shorter period of time than those which a user would schedule within their diary. The duration of tasks placed within a diary has important influence on the sequences which may occur.

Inductive Logic Programming can briefly be summarised as the inductive determination of a set of rules or first-order clausal theories from a given set of examples and background knowledge. This discipline is reviewed in “Inductive Logic Programming: Theory and Methods” by Stephen Muggleton and Luc De Raedt (Journal of Logic Programming, Vol. 19/20, pages 629-679, 1994).

The use of Inductive Logic Programming (ILP) for the production of a user model within an agent has been attempted, as explained in “The Learning Shell” by Nico Jacobs and Hendrik Blockeel (pages 50-53, “Adaptive User Interfaces, Papers from the 2000 {AAAI} Spring Symposium”, The American Association for Artificial Intelligence, California, US. See: http://citeseer.nj.nec.com/jacobs01learning.html). The model produced was to be used to predict and/or correct user actions within a Unix shell, a problem setting where the amount of background data available to use was much smaller and the complexity of the prediction required was much less than the user modelling problem solved here. The idea for the use of ILP within a diary agent for general reasoning purposes was mentioned in the article “Machine Intelligibility and the Duality Principle” by Stephen Muggleton and Donald Michie (pages 276-292, “Software Agents and Soft Computing”, 1997), however the idea involved the use of a standard ILP method on a relatively small amount of data, and no results were ever published.

Learning long sequences for classification purposes using ILP is a standard academic benchmark, however ILP has not been used to learn long sequences in order to make predictions. The model produced for prediction purposes differs from that used purely for classification in that in order to make a fully detailed prediction all the clauses must be range-restricted, hence the production of the model is a different learning problem. The method disclosed later may involve the use of pre- and post-processing, a widely known idea with regards to data processing, but not previously used in conjunction with ILP in the manner described later. This use of pre- and post-processing enables the implicit learning of real-valued background knowledge, for which no prior art has been found amongst generalising machine learning methods.

The use of the user model produced may be enhanced by the use of probability distributions to help filter out incorrect answers produced by noisy data. Using probability in conjunction with ILP is known in general, however its assistance in improving the accuracy of the answers produced by the model makes using ILP a feasible answer to the user-modelling problem.

The methods of machine learning known to be used within diary agents are case-based reasoning, reinforcement learning, and a combination of competing decision trees and neural networks (as used by Dent et al. (see above)). Case-based reasoning and reinforcement learning can make use of “extensional” background knowledge (i.e. additional facts about the user or the environment), but cannot make use of “intensional” background knowledge (e.g. ‘common sense’ or ‘rules of thumb’, more general rules which can be applied to several items/areas). The ability to include this kind of information within a user model would allow the agent to begin to reason in the same manner as its user and hence build a model that is a better representation of the user's decision making processes. The model of the user produced by either case-based reasoning, reinforcement learning or use of neural networks cannot be presented to the user in an easily understandable form, which would be a benefit when attempting to explain to the user why certain predictions were made. The model produced by construction of a decision tree is somewhat similar to that produced by Inductive Logic Programming (and subject to the same difficulties within this application area), however it would require a substantial amount of restructuring once it is produced before it could be used. The restructured model produced would be the same as that generated automatically by the use of ILP.

Inductive Logic Programming (ILP) can make use of both extensional and intensional background knowledge, and can produce a model representation that could be translated into a form which could be understood by the user. However, this cannot be simply used ‘as is’ as it is unable to cope with the data with which it would be presented for the following reasons:
The amount of information gathered from the user is too small to learn rules which accurately reflect the user's overall decision making process.
The data may contain noise which, as the total amount of data gathered is quite small, could make up a sizeable percentage of misinformation.
The amount of background knowledge required to be available is too vast for the ILP engine to be able to consider all the possible rules which it could construct as part of the user model, even with a sophisticated search algorithm in use.
The model produced must contain range-restricted clauses in order to be able to make complete predictions. ILP is biased towards producing clauses which are as general as possible whilst maintaining accuracy and will not readily produce theories of this kind.

A new approach to the use of ILP is required which will enable an existing ILP engine to be able to generate the required user model. As it may not be possible to filter out all of the noise during model generation, use of statistical measures (i.e. generation and use of probability distributions) would be a simple and efficient way to determine which generated answers should not be returned as predictions.

Referring again to the prior art, European application EP 1,158,436 relates to a method and apparatus for predicting whether a specified event will occur after a specified trigger event has occurred. This is done by creating a Bayesian statistical model from data concerning various attributes of a population of users.

International application WO 03/005248 discloses the use of Bayesian belief networks (BBNs) to determine probabilities associated with sequences of events in a system, such as an item of software or a software system being developed, for example for the purpose of providing analysis of reliability in software development, or for project management.

U.S. Pat. No. 6,067,083 also relates to Bayesian networks, and the use of Bayesian network models in diagnostic systems wherein link weights are updated experimentally.

European applications EP 0,789,307 and EP 0,887,759 relate to methods and systems for identifying at-risk patients diagnosed with depression and congestive heart failure respectively, using models created from event-related information.

### SUMMARY OF THE INVENTION

According to a first aspect of the present invention there is provided a system for deriving a user model from a plurality of event records relating to events, each event record comprising data relating to attributes of an event, the system comprising:
identifying means for identifying a plurality of sequences of event records from said plurality of event records, each sequence containing two or more event records;
clustering means for determining a plurality of sequence clusters from said plurality of sequences, each sequence cluster comprising a plurality of related sequences;
rule deriving means for analysing the sequences in a cluster and deriving one or more rules relating to the sequences of that cluster; and
user modelling means for storing rules derived in relation to separate clusters and for providing a user model comprising rules derived in relation to a plurality of clusters.

Also according to the first aspect, there is provided a method of deriving a user model from a plurality of event records relating to events, each event record comprising data relating to attributes of an event, the method comprising:
identifying a plurality of sequences of event records from said plurality of event records, each sequence containing a plurality of event records;
determining a plurality of sequence clusters from said plurality of sequences, each sequence cluster comprising a plurality of related sequences;
analysing the sequences in a cluster and deriving one or more rules relating to the sequences of that cluster; and
providing a user model based on rules derived in relation to a plurality of clusters.

According to embodiments of the present invention, there is thus provided a new method of ILP application that splits the learning of the user model into stages, produces results for each of these stages and then combines the results to produce a single user model.

The data is split into distinct clusters, each representing a sub-concept of the model to be learnt, and then the learning of each sub-concept is attempted separately. Each sub-concept is split into a number of separate learning problems which may focus on a separate attribute within each data item and only require a subset of the available background information to solve, thus reducing the number of possible solutions that the ILP engine must consider to a size that it is capable of managing. The results of each learning problem are then combined to produce a set of rules, each of which may contain range-restrictions for every attribute within each data item. Each set is then added into a database to produce the overall user model.

Meanwhile the clusters of data may also used to produce a series of probability distributions which may be stored for later use when querying the model.

Both the splitting of the overall concept into separate sub-concepts, and the subsequent splitting of each sub-concept into separate problems and combination of the results produced provide advantageous results when used with ILP to produce a user model. The splitting of each sub-concept and subsequent recombination enables the problems stated above to be overcome with regard to the use of ILP for this application and bring the additional benefit of implicit learning of real-valued background knowledge due to the imposition of range restrictions on all attributes contained within each data item.

Once a user model has been derived according to an embodiment of the present invention, it may be used in the following manners. These will be referred to as the prediction of sequences of tasks (set out below as the “second aspect” of the present invention), and the ordering of events (set out below as the “third aspect” of the present invention).

According to a second aspect of the present invention, there is provided a system for generating potential event records relating to potential events which may follow or precede known events having known event records, each event record comprising data relating to attributes of an event, from a user model comprising rules relating to sequences of event records, the system comprising:
means for identifying from said user model rules relating to sequences which include a known event record;
means for generating from said rules event records relating to events which may follow or precede the event to which said known event record relates;
means for identifying from said rules a measure of probability in relation to each generated event record;
means for selecting one or more generated event records having the highest or relatively high measures of probability as potential event records each relating to a potential event to follow or precede said known event.

Also according to the second aspect, there is provided a method for generating potential event records relating to potential events which may follow or precede known events having known event records, each event record comprising data relating to attributes of an event, from a user model comprising rules relating to sequences of event records, the method comprising the steps of:
identifying from said user model rules relating to sequences which include a known event record;
generating from said rules event records relating to events which may follow or precede the event to which said known event record relates;
identifying from said rules a measure of probability in relation to each generated event record;
selecting one or more generated event records having the highest or relatively high measures of probability as potential event records each relating to a potential event to follow or precede said known event.

According to a third aspect of the present invention, there is provided a system for determining a potential sequential order for a plurality of known events, each known event having a known event record, each event record comprising data relating to attributes of the event, from a user model comprising rules relating to sequences of event records, the system comprising:
means for designating each of said known events as a potential first or last event in a series;
means for identifying, in relation to each potential first or last event, rules from said user model, said rules relating to sequences which include the event record relating to said potential first or last event;
means for identifying from said rules event records relating to other known events which may potentially follow or precede the potential first or last event;
means for identifying from said rules measures of probability in relation to a plurality of series, each series comprising a potential first or last event and a known event which may potentially follow or precede said potential first or last event;
means for selecting one or more of said series having the highest or relatively high measures of probability as potential sequential orders for a plurality of known events.

Also according to the third aspect, there is provided a method for determining a potential sequential order for a plurality of known events, each known event having a known event record, each event record comprising data relating to attributes of the event, from a user model comprising rules relating to sequences of event records, the method comprising the steps of:
designating each of said known events as a potential first or last event in a series;
identifying, in relation to each potential first or last event, rules from said user model, said rules relating to sequences which include the event record relating to said potential first or last event;
identifying from said rules event records relating to other known events which may potentially follow or precede the potential first or last event to form a series of events;
identifying from said rules measures of probability in relation to a plurality of series, each series comprising a potential first or last event and a known event which may potentially follow or precede said potential first or last event;
selecting one or more of said series having the highest or relatively high measures of probability as potential sequential orders for a plurality of known events.

The system may be regarded as consisting of two related interacting parts:—a learning module which derives a user model according to an embodiment of the first aspect of the invention, and a query engine which allows the user model produced to be used for the prediction of sequences of tasks according to an embodiment of the second aspect of the invention, or for ordering events according to an embodiment of the third aspect of the invention. The new method of ILP application according to the above first aspect may be implemented within the learning module. Both the learning module and query engine are described below to illustrate how the user model can be produced and used.

### BRIEF DESCRIPTION OF THE DRAWINGS

Embodiments of the invention will now be described with reference to the accompanying figures in which:

FIG. 1 is a process diagram illustrating the steps involved in deriving a user model according to a preferred embodiment of the invention;

FIG. 2a is a process diagram summarising the steps involved in predicting sequences of tasks or events from a user model according to a preferred embodiment of the invention;

FIG. 2b is a process diagram illustrating in detail the steps involved in predicting sequences of tasks or events from a user model according to a preferred embodiment of the invention;

FIG. 3 is a process diagram illustrating the steps involved in reordering a given set of tasks or events from a user model according to a preferred embodiment of the invention.

### DETAILED DESCRIPTION

A first aspect of the invention relates to the construction or derivation of a user model from information such as event records taken from a user's diary. This will be explained in the following section. Second and third aspects relate to the use of such a user model for assisting in the use of scheduling systems such as electronic diary systems using such user models. These will be explained in a later section.

Construction of the User Model

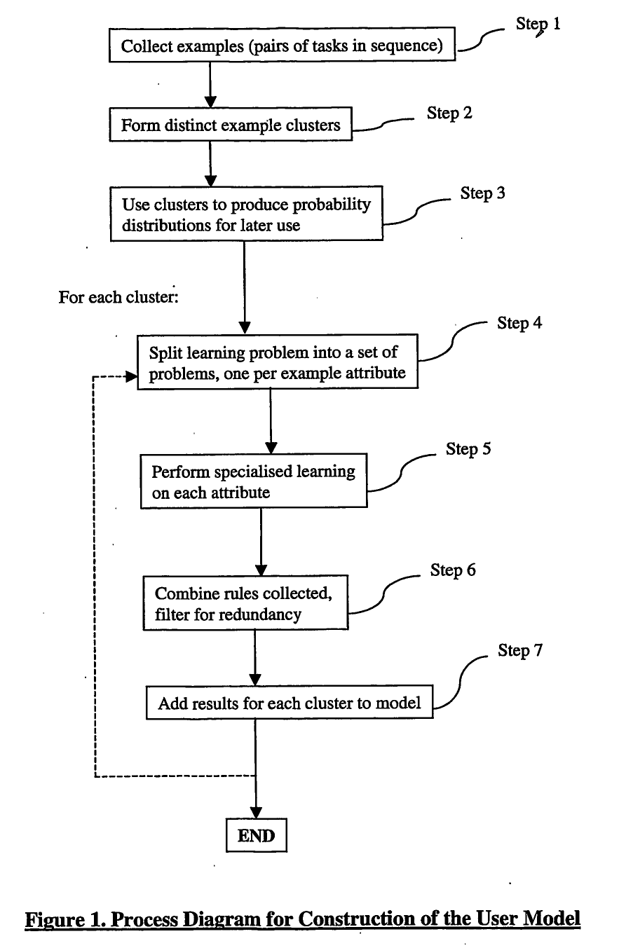

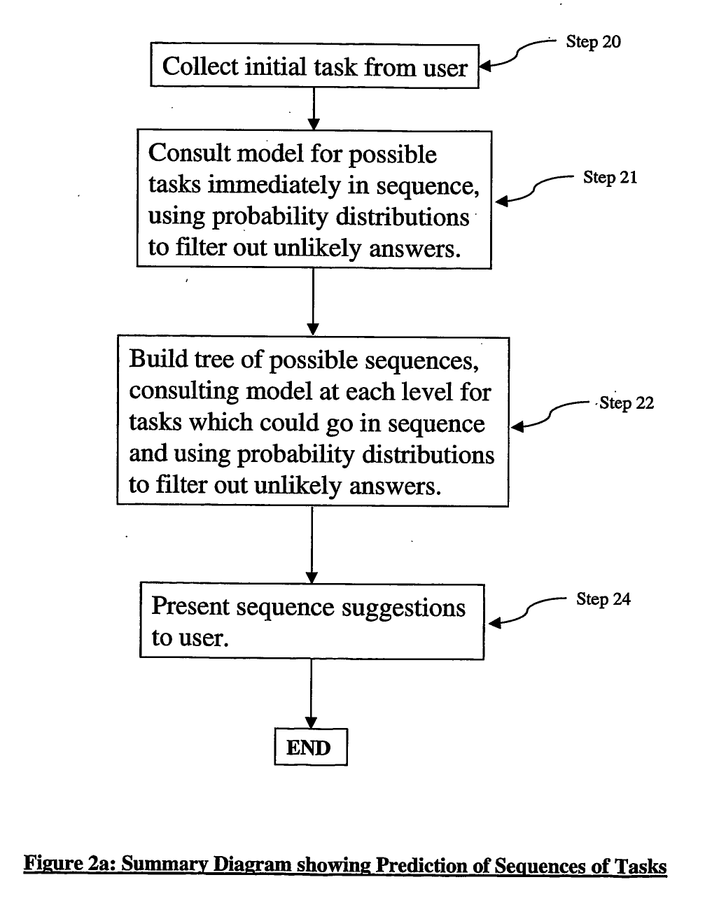

FIG. 1 gives an overview of the method used for constructing a User Model according to a preferred embodiment of the invention. A primary use of a user model derived according to an embodiment of the present invention is for the learning of sequences of pairs of tasks from a user's diary, e.g. if a user schedules a presentation on a particular project and usually schedules some preparation time in before that presentation then the system can learn this habit and either carry out the scheduling of preparation time automatically or make suggestions when the user enters the presentation task into the diary. For this example let us suppose that we have data which gives details of three types of sequences that the user may often carry out in order to demonstrate the manner in which a user model may be derived:—
1. Putting in preparation time before an administration meeting.
2. Putting in preparation time before a project meeting or presentation.
3. Putting in travel time before paying a visit to another company.

Such sequences can be derived from event records in the user's diary in a variety of ways, depending in particular on the type of diary, electronic or otherwise, that the user is using, and the format in which event records are stored in that diary. The system is of particular use in conjunction with diary systems such as those commonly used on personal computers or electronic personal organisers, but it will be noted that embodiments of the user model deriving system may receive data relating to events in the user's diary from a variety of sources. The original source of data need not even be electronic—the date could be scanned into a format suitable for the system from a hand-written diary, for example.

Event records will in general be referred to as relating to tasks from the user's diary, but it will be noted that they may equally well relate to other items such as reminders, for example. Each event record may comprise event attributes such as the TIME of the event (which may include information relating to the DATE of the event and/or the TIME-OF-DAY of the event), the TYPE of event, a SUBTYPE (which may be a LOCATION, a specific PROJECT, etc . . . ), a SUBSUBTYPE, and the DURATION of the event. In general, however, each event record will include at least:
an attribute relating to the “Event Type”; and
an attribute relating to “Event Time” (which may include “Time-of-day” and/or “Date” data).

The process now to be described with reference to FIG. 1 may be regarded as the “learning phase”, during which a “learning module” derives a user model from information provided to it. Such information may originate from the user's diary records covering a previous period—six months, or one year, for example—or may be carried out on an ongoing basis. An individual user's diary for a period of one year may contain several hundred, or several thousand event records, many of which may be of relevance to, or connected to others.

With reference to FIG. 1, once the event records have been put into a suitable format and made available to the system, the first step (Step 1) is the identification and collection of sequences of tasks. Sequences in the following example all contain data relating to a pair of tasks, but embodiments of the invention that are capable of deriving user models by identifying and analysing sequences comprising more than two event records are foreseeable.

Sequence identification may be achieved in a variety of ways. A preferred method is by use of a “distance measure”, whereby the “distance” (in what can be thought of as “event space”) between two tasks is determined according to the following formula:

$$Distance ( Task 1 , Task 2 ) = \sqrt{{\sum }_{a ∈ A} {{δ}_{a} ( {a}_{1} , {a}_{2} )}^{2}}$$

where A is the set of attributes that each task has (e.g. type/subtype, etc.) and δ_{α} is the method of calculating distance between attributes of type a. These methods may return a value of either 0 (for “the same”) or 1 (for “not the same”) for discrete attributes such as types and subtypes, or a fraction of a day (e.g. 6 hours difference=0.25) for values involving time. Sequence identification may also be dependent on factors such as probabilities—if two tasks are found to have often happened within a small period of time of each other in an individual user's diary, it can be taken as an indication that they are likely to continue to happen within a small period of time of each other in the future, and may be thus be regarded as being related for the purposes of deriving a user model for that particular user, even if the attributes of the tasks in question do not appear to imply any link. The distance function may take a variety of forms, or be weighted to give importance to some attributes (such as closeness in time) more than others (such as duration).

In determining sequences, each day, or each week, for example, may be processed individually since, at least to an initial approximation, tasks that occur one after the other, or within a period of two hours, or within a day of each other, are regarded as more likely to be related to each other, and thus more likely to be “useful” sequences in the derivation of user model. Alternatively, subject to processing power and memory limitations, all possible pairs of tasks may initially be regarded as sequences, and stored as part of the data set for further analysis on the basis of a distance function, or on the basis of the frequency of their occurrence in the user's diary during the period under examination, or otherwise.

Examples of sequences take the form of a pair of tasks joined via the ‘sequence’ relationship:

Sequence: <Type1/Subtype1,Duration1,TimeOfDay1,Day1>,<Type2/Subtype2,Duration2,TimeOfDay2,Day2>

For example, with reference to the three suggested types of sequences given earlier, the first type of sequence may include example sequences relating to the task of carrying out preparation for an administrative meeting, and the subsequent task of attending the administrative meeting, which may be shown as follows:—

sequence: <prep/admin, 2 hrs, 10-00, thursday>,<admin/meeting, 2 hrs, 13-00, thursday>

sequence: <prep/admin, 1 hr, 13-00, friday>,<admin/meeting, 2 hrs, 15-00, friday>

sequence: <prep/admin, 2 hrs, 10-00, tuesday>,<admin/meeting, 1 hr, 13-00, wednesday>

The second type of sequence may include examples of making preparations prior to project meetings and presentations (for projects which for the purposes of this example will be referred to as “projA”, “projB” and “projC”), and the subsequent attendance of those meetings, as follows:—

sequence: <prep/projA, 1 hr, 10-00, thursday>,<meeting/projA, 2 hrs, 13-00, thursday>

sequence: <prep/projB, 2 hrs, 13-00, thursday>,<presentation/projB, 1 hr, 13-00, friday>

sequence: <prep/projC, 2 hrs, 10-00, monday>,<meeting/projC, 1 hr, 13-00, wednesday>

The third type of sequence may include examples of travelling to locations of other companies, and subsequently visiting those companies, as follows:—

sequence: <travel/london, 2 hrs, 10-00, thursday>,<visit/ericsson, 2 hrs, 13-00, thursday>

sequence: <travel/cambridge, 2 hrs, 9-00, friday>,<visit/nokia, 1 hr, 11-00, friday>

sequence: <travel/bath, 4 hrs, 15-00, monday>,<visit/goulds, 5 hrs, 10-00, tuesday>

All of the listed examples (plus any others within the data set) may be collected as a single set of examples which must be split into separate clusters so that the learning of each sequence can take place separately. This splitting into clusters appears as Step 2 in FIG. 1.

The initial splitting of the data can be performed using a bottom-up agglomerative clustering algorithm over the first task of each pair to produce a group of subsets, and then using the clustering algorithm again on each subset on the second task of each pair to produce the final clusters of examples which will be used. This will provide us with groups of roughly similar examples, in the case of the above examples the data will be split into three clusters, each containing examples of a particular sequence. These sets will then be dealt with individually in the same manner.

The clusters of data may also used to produce a series of probability distributions (Step 3) which may be stored for later use when querying the model, as will be explained in the next section.

Referring next to Steps 4 and 5 of FIG. 1, each set may then be used as the example set for a series of different learning problems, each problem focusing on a different attribute within one or other of the tasks and attempting to find any “specialisations” which may be regarded as helping to characterise the particular sequence under examination. Splitting the problem into separate parts (Step 4) reduces the size of search space of possible hypotheses by reducing the size of the target clause and reducing the amount of background knowledge to be considered. A standard ILP engine is then able to cope with the reduced learning problem. Performing specialised learning on each attribute (Step 5) may introduce range restrictions. For example, the first learning problem would focus on the type of the first task of the pair in each example and would attempt to find any regularities amongst all the examples of the set for that particular attribute. Subsequent learning problems may focus on the subtype, subsubtype, and duration of the first task individually, and then a further set of learning problems would focus on the individual attributes of the second task in the same manner.

Each learning problem requires positive examples, however significantly better results may be obtained by incorporating negative examples and background knowledge into the learning problem. The positive examples are the examples contained within the set that is currently under examination. The background knowledge used for each learning task may be a subset of the entire set of background knowledge available, only those items of knowledge which directly refer to the attribute under examination being presented to the learning module for each problem. It is this splitting of the available background knowledge into subsets in conjunction with the splitting of the overall learning problem into separate smaller problems (i.e. where the length of the clauses required is much smaller) which enables the learning module to be able to tackle the overall problem of learning a user model as it reduces the number of possible hypotheses to be considered to a level which is manageable by the available ILP engine.

A set of automatically generated ‘negative examples’ may be produced for the attribute currently under examination. These may be examples of pairs of tasks that the user's diary would never produce and hence should not be thought of as being dependent on each other. Each set of negative examples may differ from the original data received in respect of the user by a small amount, and all of the negative examples within a set may differ from the original data in such a way that the ILP engine can use part of the provided background knowledge to successfully exclude all the negative examples from the solution that it produces.

If we were to generate a set of negative examples for the ‘type’ attribute of the first task in the pair then we would take a user-generated (positive) example:—

sequence: travel/london, 2 hrs, 10-00, thursday>,<visit/ericsson, 2 hrs, 13-00, thursday>

and alter one of the values, producing:—

sequence: <admin/london, 2 hrs, 10-00, thursday>,<visit/ericsson, 2 hrs, 13-00, thursday>

This may be repeated several times, using all of the examples within the set to generate negative examples. Values to be substituted into the attribute to be altered must satisfy the criterion that they must place the new example far enough away from the original example (using a distance measure similar to or the same as that described earlier in relation to the production of the original clusters, for example) that it could not be considered as part of the cluster of original examples. If the amount of data with which the module will be working is not very large, the concepts being learnt may not be accurately characterised by the examples collected, however. This criterion allows a little more ‘space’ between the positive and negative examples and hence allows the learner to produce a rule which does not adhere so tightly to the exact details of the examples collected, hence a more general overall theory is produced which should provide better results when asked for predictions.

Generation of values for substitution where the variables being examined contain real values (for example the duration of a task) may present a further complication. In order (o ensure that the values returned for a task prediction are accurate, the range of values that the variable is capable of being instantiated to may need to be limited. Values which are unacceptable as predicted values can be used to generate negative examples, but there may be cases where individual examples within the same cluster have values for a particular attribute which would be unsuitable if used within other examples in the same cluster. The two sequences listed below illustrate this problem:—

sequence: travel/cambridge, 2 hrs, 9-00, friday>,<visit/nokia, 1 hr, 11-00, friday>

sequence: travel/bath, 4 hrs, 15-00, monday>,<visit/goulds, 5 hrs, 10-00, tuesday>

The durations of the second task in each sequence are so far away from each other that any attempt to allow them to be covered by a single rule may result in distortion of the overall user model as a whole. Negative examples for the first sequence would include values such as 5 hrs and 6 hrs. Negative examples for the second sequence would include values such as 2 hrs and 1 hr. This would mean that generated negative examples may contradict other positive examples within the original set. We still need to restrict the range of values that the attribute can take, so the solution is to monitor for contradictions during the negative example generation process, and if a contradiction occurs, split the set into a pair of subsets with the contradicted positive in one set and the positive from which the contradicting negative example was generated in the other. The other positive examples and their corresponding negatives are allocated to the new subsets according to whichever example they are closest to in terms of the attribute being examined. Negative example generation then continues, with further contradictions within the subsets resulting in further splitting actions, until all the positive examples have had negative examples generated from them. The sets may then be presented to the learner as separate learning problems and the results from each problem may be added together to form a single set of possible specialisations for that attribute.

Once all of the sub-problems listed earlier are formulated with the appropriate background knowledge and generated negative examples and presented to the learner, we will have generated a collection of results for each attribute that must be combined to form the overall theory that will characterise this particular sequence.

For example, after having collected the solutions for each aspect of the sub-concept, we may have following solutions amongst our results when learning the sequence of travel time before a meeting at another company:—

sequence: <Type1/Subtype1,Dur1,Time1,Day1>,<Type2/Subtype2,Dur2,Time2,Day2>

if: Type1=travel.

sequence: <Type1/Subtype1,Dur1,Time1,Day1>,<Type2/Subtype2,Dur2,Time2,Day2>

if: Subtype1 is a location.

sequence: <Type1/Subtype1,Dur1,Time1,Day1>,<Type2/Subtype2,Dur2,Time2,Day2>

if: Subtype2 is located at Subtype1.

sequence: <Type1/Subtype1,Dur1,Time1,Day1>,<Type2/Subtype2,Dur2,Time2,Day2>

if: Dur1<3 hrs.

sequence: <Type1/Subtype1,Dur1,Time1,Day1>,<Type2/Subtype2,Dur2,Time2,Day2>

if: Dur1>3 hrs AND Dur1<6 hrs.

sequence: <Type1/Subtype1,Dur1,Time1,Day1>,<Type2/Subtype2,Dur2,Time2,Day2>

if: Dur2>5 hrs AND Dur2<8 hrs.

sequence: <Type1/Subtype1,Dur1,Time1,Day1>,<Type2/Subtype2,Dur2,Time2,Day2>

if: Dur2<3 hrs.

sequence: <Type1/Subtype1,Dur1,Time1,Day1>,<Type2/Subtype2,Dur2,Time2,Day2>

if: Type2=visit.

As can be seen, some of these rules contradict each other, however they are all true for some (if not all) of the examples given for this sequence. This contradiction will be dealt with when we construct the rules which form the theory. To construct the rules, we take the first two sets of results and combine them by adding all the rules from the first set to all of the rules from the second set. Using the results listed above this would give us one rule at this point:—

sequence: <Type1/Subtype1,Dur1,Time1,Day1>,<Type2/Subtype2,Dur2,Time2,Day2>

if: Type1=travel AND Subtype1 is a location.

The resultant set of rules is then combined with the next set of learning results in the same way, and the process is repeated for each set of results collected. If we combined all the rules listed above we would generate the following set of rules:—

sequence: <Type1/Subtype1,Dur1,Time1,Day1>,<Type2/Subtype2,Dur2,Time2,Day2> if:

Type1=travel AND Subtype1 is a location AND

Type2=visit AND Subtype2 is located at Subtype1 AND

Dur1<3 hrs AND Dur2<3 hrs.

sequence: <Type1/Subtype1,Dur1,Time1,Day1>,<Type2/Subtype2,Dur2,Time2,Day2> if:

Type1=travel AND Subtype1 is a location AND

Type2=visit AND Subtype2 is located at Subtype1 AND

Dur1<3 hrs AND Dur2>5 hrs AND Dur2<8 hrs.

sequence: <Type1/Subtype1,Dur1,Time1,Day1>,<Type2/Subtype2,Dur2,Time2,Day2> if:

Type1=travel AND Subtype1 is a location AND

Type2=visit AND Subtype2 is located at Subtype1 AND

Dur1>3 hrs AND Dur1<6 hrs AND Dur2<3 hrs.

sequence: <Type1/Subtype1,Dur1,Time1,Day1>,<Type2/Subtype2,Dur2,Time2,Day2> if:

Type1=travel AND Subtype1 is a location AND

Type2=visit AND Subtype2 is located at Subtype1 AND

Dur1>3 hrs AND Dur1<6 hrs AND Dur2>5 hrs AND Dur2<8 hrs.

Each rule may be tested for contradictions by evaluating it over the set of positive examples that it is supposed to characterise. If the rule does not cover any of the examples (i.e. it does not give the answer ‘true’ when given any of the pairs of tasks), then it is discarded. This test would remove rules containing contradictions such as the second and third rules in the results shown above. The set of rules is filtered to remove those rules subsumed by other rules, and each rule is then filtered to remove any redundant elements; for example the first rule contains two literals which say the same thing, so one of these may be removed (Step 6). Combining the collected results ensures all rules include relevant range restrictions for each attribute, enabling prediction of complete tasks for sequences.

Having performed these final filtering stages we are then left with a set of rules which form a theory that characterises the set of sequence we were trying to learn. This process is repeated for every cluster of examples that was initially generated and all the rules added to a collection which encapsulates the entire user model (Step 7).

Use of the User Model

Having constructed a user model, there now follow sections providing descriptions of how such a user model may be used. There are two principal ways in which the user model can aid a diary assistant: predicting one or more tasks having been given one or more others, and arranging a group of given tasks into an order based on prior experience. The following sections describe a prediction method and a method of ordering groups of tasks with the aid of a user model derived according to an embodiment of the present invention.

(i) Predicting Sequences

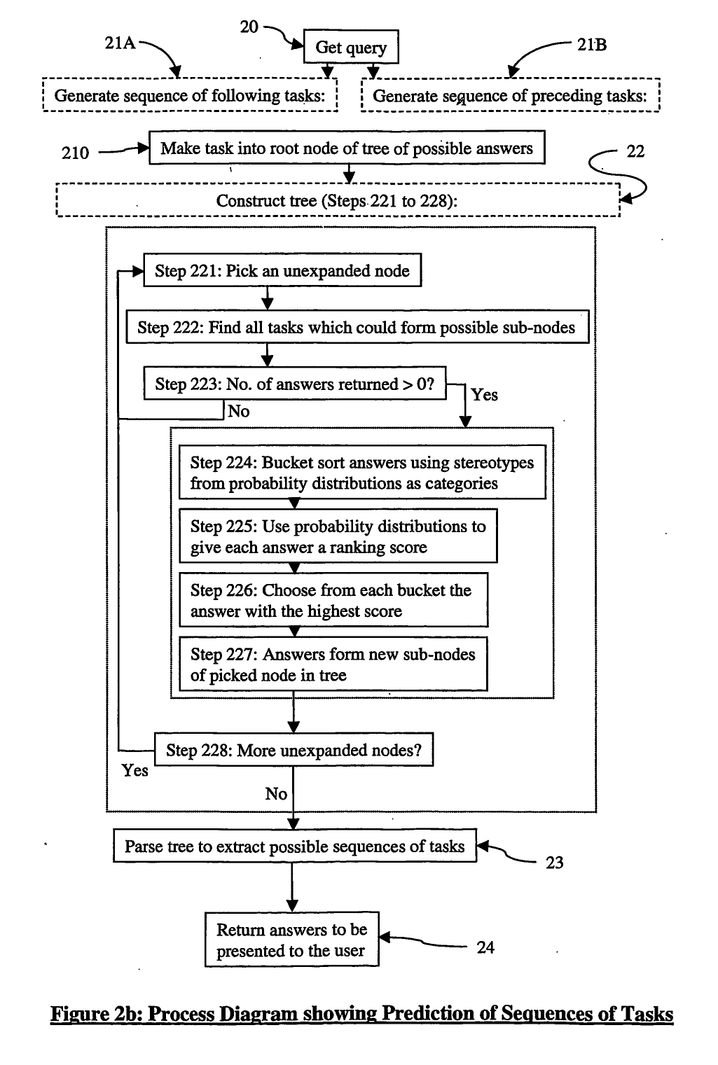

FIG. 2a gives an overview of a method for predicting sequences of tasks following derivation of a user model in accordance with a preferred embodiment of the present invention. FIG. 2b shows the steps of such a method in greater detail.

Referring first to FIG. 2a, when asked to suggest possible tasks, the query engine takes the task given (Step 20) and feeds it into the database of rules. It collects two lists; one of possible tasks to schedule before the user's task, and one of possible tasks to schedule after the user's task. The process for generating the sequence of “following tasks” (21A in FIG. 2b) and the process for generating the sequence of “preceding tasks” (21B in FIG. 2b) are broadly similar, and are represented by a common step 21 in FIG. 2a. Each list is processed (Step 22) to find the most likely candidate for scheduling and the two answers returned (Step 24). If there is no possible suggestion for either answer then an empty task which describes itself as ‘No Answer’ may be returned as an indicator of this situation.

Referring next to FIG. 2b, it will first be noted that items 21A and 21B, while corresponding to Step 21 in FIG. 2a, are not separate processing steps; they are high-level descriptions that indicate which prediction task is currently being carried out. Item 21A means that predictions will be made for sequences of tasks that follow the task given by the user. Item 21B means that predictions will be made for sequences of tasks that precede the task given by the user. For each of the two processes, Steps 210, Steps 221 to 228, and Step 23 are performed, once for the process for generating the sequence of “following tasks”, and once for the process for generating the sequence of “preceding tasks”. These processes may performed either concurrently or one after the other. Similarly it will be noted that item 22, while corresponding broadly to Step 22 in FIG. 2a, is not a separate step, but is simply a high-level description of the process carried out in Steps 221 to 228.

Starting therefore from Step 210, the prediction process is carried out by constructing a tree where each node in the tree contains a possible task prediction. At the root of the tree is a node containing the task entered by the user. The next layer of nodes will contain tasks that could be suggested for scheduling in immediate sequence with the user's task. Each of these nodes will form a sub-tree where the next layer of nodes represents tasks that have been suggested for scheduling in immediate sequence with the root of that sub-tree. The likelihood of each task within the tree is determined by the likelihood of its parent multiplied by the probability of that task being scheduled in immediate sequence with its parent. The construction of these probabilities is described in more detail in Steps 225 to 227.

In Step 221, one of the nodes in the tree must be chosen for further expansion. On the first occasion, the only unexpanded node in the tree is the node containing the user's task. On all further occasions, the tree will contain nodes below the root node that represent possible sequences of tasks that have been identified. All paths from the root node to the leaf nodes represent possible sequence predictions that have been discovered.

Step 222: Having picked a node containing a task, possible tasks that could be scheduled in sequence with that task must be determined. When asked to suggest possible tasks, the query engine takes the task given, feeds it into the database of rules and returns a list of suggestions.

Step 223: If the number of suggestions returned is less than one (i.e. if there are no suggestions) then another unexpanded node in the tree is chosen, assuming one exists.

Step 224: At this stage, several possible tasks may have been generated which only differ by a very small amount (for example one task may have a preferred time half an hour later than another task), so the list of answers returned may need to be sorted into sub-lists of similar tasks. It can then be ascertained which is the most suitable candidate from each sub-list.

All the possible stereotypes for the tasks can be determined by looking at the data representing the results of the clustering carried out during the learning process. When the examples were originally clustered, a separate set of data was saved in which was stored the results of clustering the examples over the first task (task A) in the sequence and the results of clustering only over the second task (task B) in the sequence. Taking the mode of each task A for each cluster within the first set of results will produce examples of the possible stereotypes for task A. The same process can be carried out using the second set of results to produce a set of stereotypes for task B. The set of stereotypes produced will depend on whether the list of answers produced earlier was for preceding tasks (in which case we use task A stereotypes) or following tasks (for which task B stereotypes will be used).

Step 225: The generation of the Dirichlet distributions for use when rating answers makes use of information (described in Step 224) that was saved at the model learning stage. This information represents the basis from which the set of distributions representing P(B|A) and P(A|B) can be calculated. Two sets of distributions are created; one which describes P(B|A) and the other describes P(A|B). In both cases A is chronologically the first task in the sequence and B the second. If we are looking at the list of possible tasks which could follow that specified by the user then we would use the set of P(B|A) distributions as task A is given and we wish to ascertain the probability of each possible task B that has been generated. Conversely, if we are looking for a task which would precede the user's task then we would use the set of P(A|B). We are working with a set of distributions rather than simply one because we need to construct a separate distribution for each possible task given by the user (i.e. each distinct ‘A’). Once we know the user's task then ideally we would concentrate on an individual distribution, however the distributions are created using stereotypes for different task types (the set of stereotypes used contains the mode of each cluster generated during the learning process) and the user's task may not match exactly any of the tasks over which the distributions are created. Therefore we pick all the distributions for which the distance from the base task to the user's task is closer than the threshold distance used at the clustering stage of the learning process.

The rating for each task is generated by adding together the rating obtained from each selected distribution. For each distribution, the probability given to the stereotype closest to the task being rated is divided by its distance from the task to form a rating for that task

Step 226: The answer from each sub-list having the highest score is chosen.

Step 227: Each chosen answer, if its score is high enough, forms one sub-node of the node picked in Step 221.

Step 228: The same procedure is carried out for other unexpanded nodes of the tree until no more nodes exist.

Step 23: The tree that is produced is parsed to generate a list of all possible sequences of tasks. Each path within the tree from the root node to a leaf node represents a sequence that the user could possibly want to schedule. In addition, each sub-path (i.e. a path from the root node heading towards a node somewhere between it and a lead node) also represents a possible sequence.

If the sequence of “preceding” tasks is to be generated after the sequence of “following” tasks, it is after this stage. Thus Steps 210 to 23 are performed again.

Step 24: The sequences of tasks are returned for presentation to the user since they are all valid sequences for the task originally entered. If there are no sequences to be returned for either the following or preceding prediction then an empty task that describes itself as ‘No Answer’ may be returned as an indicator of this situation.

Thus, in summary of the above, when asked to suggest possible tasks, the query engine takes the task given and feeds it into the database of rules. It constructs two trees, one that represents the possible sequences that could follow the query task and the other that represents possible sequences that could precede the query task. For each tree, the user's task is placed in the root node and the tasks that are identified as possibly being directly in sequence with it form sub-nodes of the root. Each layer of the tree is constructed in turn, using the tasks contained within the previous layer as new queries for the rule base. Each query to the rule base produces a list of tasks that, according to the previously constructed model of the user, could be scheduled in immediate sequence with the task currently being used in the query. Each list is then processed to find the most likely candidates for scheduling.

The generation of Dirichlet distributions for use when rating answers may make use of information saved at the model learning stage. When the examples are originally clustered, a separate set of data may be saved in which may be stored the results of clustering the examples over the first task (task A) in the sequence and the results of clustering only over the second task (task B) in the sequence. This information represents the basis from which the set of distributions representing p(B|A), defined as “the probability of B given A”, and p(A|B), defined as “the probability of A given B”, can be calculated. As the method for generating distributions which deal with prediction of following tasks and distributions which deal with prediction of preceding tasks is the same, it has only been described fully from the point of view of predicting a following task.

All the possible stereotypes for task B can be determined by looking at the data representing the results of clustering over task B and taking the mode of each task B within a cluster as this will produce examples of the possible values for task B encountered so far. The data representing the results of clustering over task A will contain a set of examples for each distinct task A encountered. Each set can be used to create a Dirichlet distribution p(B|A) by counting the number of occurrences of each type of task B that follows the given task for that distribution and then normalising the counts to produce a probability. This version of the Dirichlet distribution uses a normal prior during construction, but leaves the possibility open to use of more biased priors later if required.

The most likely candidates from the two lists of tasks produced earlier are generated by sorting each list into sub-lists of similar tasks (we may have generated several possible tasks which only differ by a very small amount, for example one task may have a preferred time half an hour later than another task), and then ascertaining the most suitable candidate from each sub-list using the probability distributions created from the original set of examples collected. Two sets of distributions are created; one which describes P(B|A) and the other describes P(A|B). In both cases A is chronologically the first task in the sequence and B the second. If we are looking at the list of possible tasks which could follow that specified by the user then we would use the set of P(B|A) distributions as task A is given and we wish to ascertain the probability of each possible task B that has been generated. Conversely, if we are looking for a task which would precede the user's task then we would use the set of P(A|B). We are working with a set of distributions rather than simply one because we need to construct a separate distribution for each possible task given by the user (i.e. each distinct ‘A’). Once we know the user's task then ideally we would concentrate on an individual distribution, however the distributions are created using stereotypes for different task types (the set of stereotypes used contains the mode of each cluster generated during the learning process) and the user's task may not match exactly any of the tasks over which the distributions are created. Therefore we pick all the distributions for which the distance from the base task to the user's task is closer than the threshold distance used at the clustering stage of the learning process.

Task ratings are generated by adding together the rating from each selected distribution in turn. For each distribution, the probability given to the stereotype that is closest to the task being rated is divided by its distance from the task to form the rating for that task. This allows us to attempt to distinguish between tasks that only differ by small amounts and is based on the idea of the influence of each point in the instance space represented by a stereotype degrading with distance (hence the sum of ratings, which is a simple method of acknowledging influence from more than one point). The tasks with the highest rating within each of the sub-lists generated earlier are used to form the next layer of nodes in the tree under the node that has been selected for further expansion.

Once the tree has been completely constructed (i.e. all the leaf nodes of the tree contain tasks that do not have any further tasks that can be scheduled in sequence) the tree is parsed to produce candidate sequences to suggest to the user. Each path within the tree from the root node to a leaf node represents a sequence that the user could possibly want to schedule. In addition, each sub-path (i.e. a path from the root node heading towards a node somewhere between it and a lead node) also represents a possible sequence. The likelihood of each sequence within the tree being a suitable sequence to suggest is determined by the combined likelihood of all the tasks within the sequence. If there is no possible suggestion for either a preceding or following sequence of tasks then an empty task that describes itself as ‘No Answer’ is returned as an indicator of this situation.

(ii) Ordering Groups of Tasks

If given a group of tasks and told to produce a suitable order for them, the query engine will attempt to build the longest sequence possible from the given tasks by working with tree structures. Each task in turn from the set given will be used as the root of a tree of tasks where each sub-node represents a task which follows its parent node in sequence. The root task is used as a query task to gather possible tasks which could follow it in the same way as described in the previous subsection. The tasks retrieved are filtered, and any which match any members of the set of given tasks are kept and stored as sub-nodes. The process is then repeated for each sub-node, but with the set of possible tasks which could follow no longer containing any of the tasks represented in the path from the root task to the current sub-node. This process continues iteratively until the entire tree has been constructed. Circular paths are avoided due to the limited set of tasks to be allocated.

Once the full tree has been constructed, the longest path within the tree, and the sequence of tasks that it represents, is determined. The whole process is repeated with each task within the given set as the root task of the tree, and the longest paths from each tree are compared to find the longest possible sequence which could be constructed from the given tasks. The tasks which could not be included in this sequence are then added either to the beginning or the end of the sequence depending on their relation to tasks already within the sequence and feasibility in terms of time and duration. This final sequence is returned as the best answer the model can give. If more than one sequence reaches the greatest constructed length, then the original set of tasks may be returned as there may be no reason to choose between the possible answers.

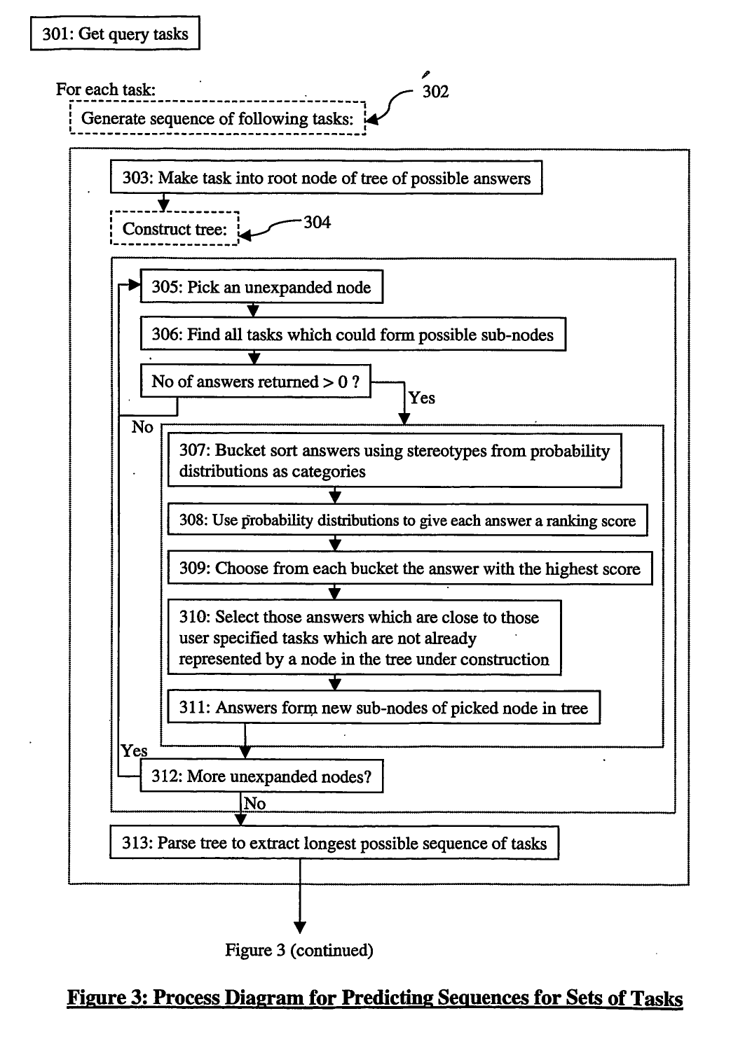

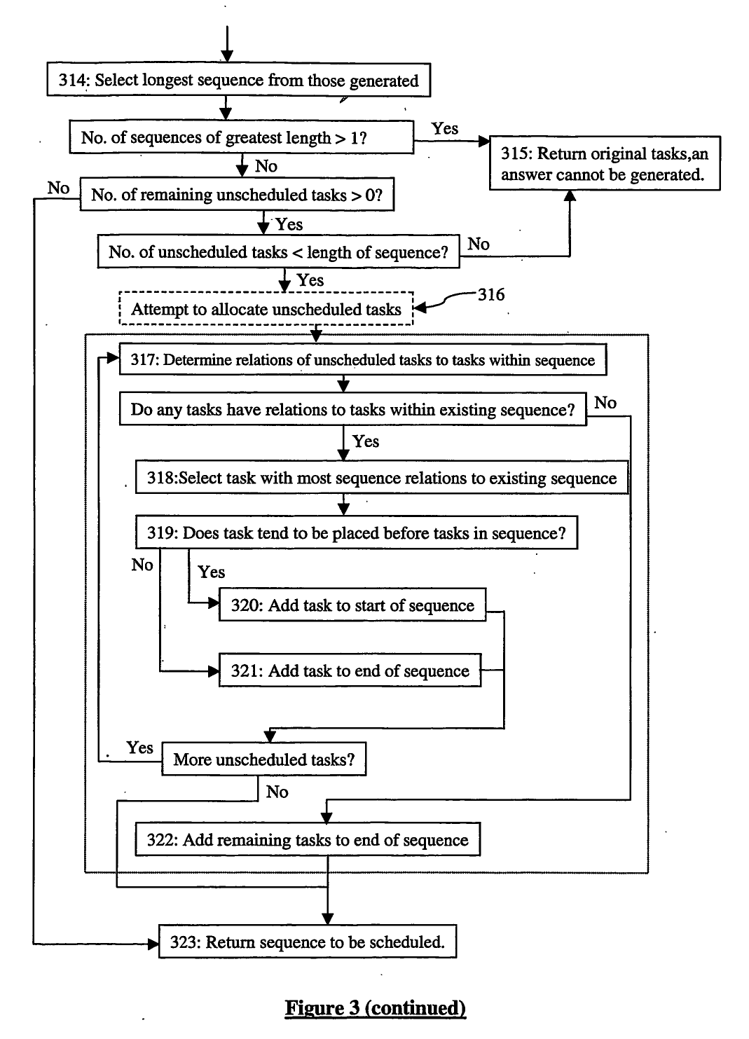

FIG. 3 shows the process for re-ordering a given set of tasks following derivation of a user model in accordance with a preferred embodiment of the present invention. The steps of this process will be described with reference to this Figure.

Steps 301 to 312: If given a group of tasks and told to produce a suitable order for them, the query engine will attempt to build the longest sequence possible from the given tasks by working with tree structures. Each task in turn from the set given will be used as the root of a tree of tasks where each sub-node represents a task which follows its parent node in sequence. The root task is used as a query task to gather possible tasks that could follow it in the same way as described in the previous subsection, with reference to Steps 210 to 228 of FIG. 2b. There is one additional step (described below) that is inserted between Steps 226 and 227 of the earlier process. This appears as Step 310 in FIG. 3.

Step 310: The list of tasks is processed to find any that match members of the set of given tasks. Tasks that match a member of this set are kept and stored as sub-nodes of the picked node in the tree under construction. The set of tasks that the list is compared to is equal to the original set of tasks entered by the user minus those tasks that are already represented in the tree in the path from the root node to the node that was picked for expansion.

This process continues iteratively until the entire tree has been constructed. Circular paths are avoided due to the limited set of tasks to be allocated. We must then parse tree to extract longest possible sequence of tasks.

Step 313: The tree is parsed to find the longest direct path from the root node to a leaf node. The sequence that the path represents is stored to be processed later. If more than one sequence is of the greatest length within the tree then all are kept.

Steps 303 to 313, for which Item 302 is a high-level description, are then repeated for each of the other tasks within the group originally entered by the user. It will also be noted that within this, Item 304 is a high-level description for Steps 305 to 312

Step 314: The longest sequence within the entire set results collected from generating trees starting within each task within the group is selected. If more than one sequence is of the greatest length, or if the subset of the original set of tasks that is represented by the sequence is smaller than the remaining set of tasks then we go to Step 315, otherwise we go to the steps under the heading of Item 316.

Step 315: A satisfactory answer cannot be produced, therefore the list of tasks will just be returned in the order that the user entered them.

Item 316: This is a high-level description of the processing carried out in Steps 317 to 322. The remaining number of tasks to be added to the sequence is smaller than the sequence itself; therefore we will add each of these tasks in turn to one end of the sequence.

Step 317: Previously learned knowledge (i.e. the user model) is used to identify any existing sequential relationships between the unscheduled tasks to be added and the constructed sequence of tasks.

If none of the unscheduled tasks have been observed in sequence with the tasks contained within the sequence then we have no further information to use, and we proceed to Step 322.

Step 318: The unscheduled task with the highest number of recorded relations is selected to be added to the sequence.

Steps 319 to 321: If the task selected has more relations describing it as a preceding task than a following task then it is added to the beginning of the sequence, otherwise it is added to the end of the sequence.

If more unscheduled tasks exist the above steps are repeated until either the only tasks remaining have no recorded relationships with tasks within the constructed sequence, in which case we proceed to Step 322, or there are no more tasks to be scheduled, in which case we proceed to Step 323.

Step 322: The remaining tasks are added to the end of the sequence because we have no further information on where to place them. Since this will only occur if the constructed sequence is larger than the number of unscheduled tasks and the user is unlikely to enter more than 4 or 5 tasks at a time, the maximum number of tasks that could be placed at the wrong end of the sequence is quite small and can easily be moved by the user if they do not agree with the prediction.

Step 323: The constructed sequence is returned as suggestion for the user.

By virtue of the above process, the query engine is able to build the longest sequence of tasks possible that are in a suitable order, from a given group of tasks, according to information from a user model containing rules are characteristic of a specific user relating to sequences of event records, such as that described in the earlier part of this description.

Unless the context clearly requires otherwise, throughout the description and the claims, the words “comprise”, “comprising” and the like are to be construed in an inclusive as opposed to an exclusive or exhaustive sense; that is to say, in the sense of “including, but not limited to”.

### BIBLIOGRAPHY

1. ‘The Learning Shell’, Nico Jacobs, pp 50-53 “Adaptive User Interfaces, Papers from the 2000 {AAAI} Spring Symposium”, Editors: Seth Rogers and Wayne Iba, The American Association for Artificial Intelligence, 445 Burgess Drive, Menlo Park, Calif. 94025. [http://citeseer.nj.nec.com/jacobs01learning.html]
2. ‘A learning Interface Agent for Scheduling Meetings’, Robyn Kozierok and Pattie Maes, pp 81-88, Proceedings of the International Workshop on Intelligent User Interfaces, Editors: Wayne D. Gray and William E. Hefley and Dianne Murray, ACM Press, New York, N.Y., USA, January 1992.
3. ‘A Personal Learning Apprentice’, Lisa Dent and Jesus Boticario and John McDermott and Tom Mitchell and David Zabowski, Proceedings of the Tenth National Conference on Artificial Intelligence, pp 96-103, July, 1992. [http://www-2.cs.cmu.edu/afs/cs.cmu.edu/project/theo-11/www/aaai92.ps]
4. ‘Inductive Logic Programming: Theory and Methods’, Muggleton, S. and De Raedt, L., Journal of Logic Programming, Vol 19/20, pp 629-679, 1994. http://citeseer.nj.nec.com/cache/papers/cs/6283/ftp:zSzzSzftp.cs.york.ac.ukzSzpubzSzML_GROUPzSzPaperszSzlpj.pdf/muggleton94inductive.pdf
5. ‘An Agent Oriented Schedule Management System: IntelliDiary’, Yuji Wada, Akira Kawamura, Francis G. McCabe, Masatoshi Shiouchi, Yoshiaki Teramoto and Yuji Takada, In: Proceedings of the First International Conference on the Practical Application of Intelligent Agents and Multi-Agent Systems, pages 655-667, London, UK, April 1996. http://magazine.fujitsu.com/us/vol33-2/paper11.pdf
6. Retsina Semantic Web Calendar Agent, Intelligent Software Agents Laboratory, The Robotics Institute, Carnegie-Mellon University. URL: http://www.daml.ri.cmu.edu/site/projects/RDFCalendar/
7. ‘Machine Intelligibility and the Duality Principle’, Stephen Muggleton and Donald Michie, pp 276-292, “Software Agents and Soft Computing”, 1997. [http://www.doc.ic.ac.uk/˜shm/Papers/bttj.ps.gz] or [http://citeseer.nj.nec.com/cache/papers/cs/2445/ftp:zSzzSzftp.comlab.ox.ac.ukzSzpubzSzPackageszSzlLPzSzPaperszSzbttj.pdf/muggleton96machine.pdf]
8. ‘Inductive Task Modelling for User Interface Customization’, David Maulsby, Intelligent User Interfaces 1997: 233-236. [http://www.iuiconf.org/97pdf/1997-002-0033.pdf]
9. ‘Extracting Behavioural Patterns form Relational History Data’, Hiroshi Motoda, Takashi Washio, Toshihiro Kayama, Proc. of the Workshop “Machine Learning for User Modeling” held in conjunction with Sixth International Conference on User Modeling, (June 1997) Chia Laguna, Sardinia, Italy. http://citeseer.nj.nec.com/88185.html
10. ‘Emotionally Expressive Agents’, Magy Seif El-Nasr, Thomas R. Ioerger, John Yen, Donald H. House, Frederic I. Parke, Proceedings of Computer Animation '99, Switzerland, 1999. http://citeseer.nj.nec.com/69733.html

1. A system for deriving a user model from a plurality of event records relating to events, each event record comprising data relating to attributes of an event, the system comprising:
identifying means for identifying a plurality of sequences of event records from said plurality of event records, each sequence containing two or more event records;
clustering means for determining a plurality of sequence clusters from said plurality of sequences, each sequence cluster comprising a plurality of related sequences;
rule deriving means for analysing the sequences in a cluster and deriving one or more rules relating to the sequences of that cluster; and
user modelling means for storing rules derived in relation to separate clusters and for providing a user model comprising rules derived in relation to a plurality of clusters.

2. A system according to claim 1, wherein each event record comprises data relating to one or more of the following attributes of an event: the type of the event; the location of the event; the duration of the event; the date of the event; and the time-of-day of the event.

3. A system according to claim 1, wherein each event record comprises event-time data relating to the date and/or time-of-day of an event, and event-type data relating to the type of event.

4. A system according to claim 1, wherein a sequence of event records contains event records relating to two events.

5. A system according to claim 1, further comprising means for evaluating a measure of the distance between events according to a predetermined event-space distance function.

6. A system according to claim 5, wherein said identifying means identifies sequences with reference to the value of the distance measure between events.

7. A system according to claim 1, further comprising:
means for generating, in relation to each cluster, artificial sequences, each artificial sequence containing two or more event records, said artificial sequences being different to the sequences of that cluster that have been identified from said event records; and
means for deriving a measure of sequence probability for each artificial sequence indicative of the likelihood that said artificial sequence contains event records relating to two or more related events.

8. A system according to claim 7, wherein said measure of sequence probability of an artificial sequence is derived with reference to a measure of the distance between the events, evaluated according to a predetermined event-space distance function.

9. A system according to claim 7, further comprising means for designating an artificial sequence as a positive or a negative example of the user's behaviour with reference to said measure of sequence probability, and wherein the rule deriving means takes account of negative examples within a cluster when deriving rules relating to the sequences of that cluster.

10. A system according to claim 1, further comprising means for analysing said sequence clusters and determining therefrom a probability distribution in respect of the types of sequences identified by said identifying means.

11. A system according to claim 1, wherein said event records relate to activities of an individual user.

12. A method of deriving a user model from a plurality of event records relating to events, each event record comprising data relating to attributes of an event, the method comprising:
identifying a plurality of sequences of event records from said plurality of event records, each sequence containing a plurality of event records;
determining a plurality of sequence clusters from said plurality of sequences, each sequence cluster comprising a plurality of related sequences;
analysing the sequences in a cluster and deriving one or more rules relating to the sequences of that cluster; and
providing a user model based on rules derived in relation to a plurality of clusters.

13. A method according to claim 12, wherein each event record comprises data relating to one or more of the following attributes of an event: the type of the event; the location of the event; the duration of the event; the date of the event; and the time-of-day of the event.

14. A method according to claim 12, wherein each event record comprises event-time data relating to the date and/or time-of-day of an event, and event-type data relating to the type of event.

15. A method according to claim 12, wherein a sequence of event records contains event records relating to two events.

16. A method according to claim 12, further comprising a step of evaluating a measure of the distance between events according to a predetermined event-space distance function.

17. A method according to claim 16, wherein said identifying step comprises identifying sequences with reference to the value of the distance measure between events.

18. A method according to claim 12, further comprising:
a step of generating, in relation to each cluster, artificial sequences, each artificial sequence containing two or more event records, said artificial sequences being different to the sequences of that cluster that have been identified from said event records; and
a step of deriving a measure of sequence probability for each artificial sequence indicative of the likelihood that said artificial sequence contains event records relating to two or more related events.

19. A method according to claim 18, wherein said measure of sequence probability of an artificial sequence is derived with reference to a measure of the distance between the events, evaluated according to a predetermined event-space distance function.

20. A method according to claim 18, further comprising a step of designating an artificial sequence as a positive or a negative example of the user's behaviour with reference to said measure of sequence probability, and wherein the rule deriving step takes account of negative examples within a cluster when deriving rules relating to the sequences of that cluster.

21. A method according to claim 12, further comprising a step of analysing said sequence clusters and determining therefrom a probability distribution in respect of the types of sequences identified by said identifying means.

22. A method according to claim 12, wherein said event records relate to activities of an individual user.

23. A system for generating potential event records relating to potential events which may follow or precede known events having known event records, each event record comprising data relating to attributes of an event, from a user model comprising rules relating to sequences of event records, the system comprising:
means for identifying from said user model rules relating to sequences which include a known event record;
means for generating from said rules event records relating to events which may follow or precede the event to which said known event record relates;
means for identifying from said rules a measure of probability in relation to each generated event record;
means for selecting one or more generated event records having the highest or relatively high measures of probability as potential event records each relating to a potential event to follow or precede said known event.

24. A system according to claim 23, further comprising means for providing said selected event records as suggestions to a user.

25. A system according to claim 23, further comprising means for incorporating said selected event records in a user's diary.

26. A system according to claim 23, wherein said known event records relate to activities of an individual user.

27. A system for determining a potential sequential order for a plurality of known events, each known event having a known event record, each event record comprising data relating to attributes of the event, from a user model comprising rules relating to sequences of event records, the system comprising:
means for designating each of said known events as a potential first or last event in a series;
means for identifying, in relation to each potential first or last event, rules from said user model, said rules relating to sequences which include the event record relating to said potential first or last event;
means for identifying from said rules event records relating to other known events which may potentially follow or precede the potential first or last event;
means for identifying from said rules measures of probability in relation to a plurality of series, each series comprising a potential first or last event and a known event which may potentially follow or precede said potential first or last event;
means for selecting one or more of said series having the highest or relatively high measures of probability as potential sequential orders for a plurality of known events.

28. A system according to claim 27, further comprising means for providing said selected sequential orders as suggestions to a user.

29. A system according to claim 27, further comprising means for incorporating said selected sequential orders in a user's diary.

30. A system according to claim 27, wherein said known event records relate to activities of an individual user.

31. A system according to claim 23, wherein said user model is a user model derived using a method of deriving a user model from a plurality of event records relating to events, each event record comprising data relating to attributes of an event, the method comprising:
identifying a plurality of sequences of event records from said plurality of event records, each sequence containing a plurality of event records;
determining a plurality of sequence clusters from said plurality of sequences, each sequence cluster comprising a plurality of related sequences;
analysing the sequences in a cluster and deriving one or more rules relating to the sequences of that cluster; and
providing a user model based on rules derived in relation to a plurality of clusters

32. A method for generating potential event records relating to potential events which may follow or precede known events having known event records, each event record comprising data relating to attributes of an event, from a user model comprising rules relating to sequences of event records, the method comprising the steps of:
identifying from said user model rules relating to sequences which include a known event record;
generating from said rules event records relating to events which may follow or precede the event to which said known event record relates;
identifying from said rules a measure of probability in relation to each generated event record;
selecting one or more generated event records having the highest or relatively high measures of probability as potential event records each relating to a potential event to follow or precede said known event.

33. A method according to claim 32, further comprising a step of providing said selected event records as suggestions to a user.

34. A method according to claim 32, further comprising a step of incorporating said selected event records in a user's diary.

35. A method according to any of claims 32 to 34, wherein said known event records relate to activities of an individual user.

36. A method for determining a potential sequential order for a plurality of known events, each known event having a known event record, each event record comprising data relating to attributes of the event, from a user model comprising rules relating to sequences of event records, the method comprising the steps of:
designating each of said known events as a potential first or last event in a series;
identifying, in relation to each potential first or last event, rules from said user model, said rules relating to sequences which include the event record relating to said potential first or last event;
identifying from said rules event records relating to other known events which may potentially follow or precede the potential first or last event to form a series of events;
identifying from said rules measures of probability in relation to a plurality of series, each series comprising a potential first or last event and a known event which may potentially follow or precede said potential first or last event;
selecting one or more of said series having the highest or relatively high measures of probability as potential sequential orders for a plurality of known events.

37. A method according to claim 36, further comprising a step of providing said selected sequential orders as suggestions to a user.

38. A method according to claim 36, further comprising a step of incorporating said selected sequential orders in a user's diary.

39. A method according to claim 36, wherein said known event records relate to activities of an individual user.

40. A method according to claim 32, wherein said user model is a user model derived using a method of deriving a user model from a plurality of event records relating to events, each event record comprising data relating to attributes of an event, the method comprising:
identifying a plurality of sequences of event records from said plurality of event records, each sequence containing a plurality of event records;
determining a plurality of sequence clusters from said plurality of sequences, each sequence cluster comprising a plurality of related sequences;
analysing the sequences in a cluster and deriving one or more rules relating to the sequences of that cluster; and
providing a user model based on rules derived in relation to a plurality of clusters.
